(19) United States
(12) Patent Application Publication
(10) Pub. No.: US 2026/0338418 A1
(43) Pub. Date: Oct. 29, 2026

(54) SECONDARY REFLECTOR

(71) Applicant: FRENELL IP GmbH, Karlsruhe (DE)

(72) Inventor: Georg SCHWAB, Karlsruhe (DE)

(73) Assignee: FRENELL IP GmbH, Karlsruhe (DE)

(21) Appl. No.: 19/101,642

(22) PCT Filed: Aug. 8, 2023
(86) PCT No.: PCT/DE2023/100580

§ 371 Date: Feb. 6, 2025

(30) Foreign Application Priority Data
Aug. 10, 2022 (DE) 10 2022 120 177.5

(51) Int. Cl. F24S 23/70; F24S 23/74; F24S 23/79

(52) U.S. Cl. CPC F24S 23/82; F24S 23/74; F24S 23/79; F24S 2023/872

(57) ABSTRACT

The invention relates to a detachable suspension of the reflector element (5), which allows for simple suspension and is achieved by connecting elements (9) glued to the back of the reflector elements (5). These connecting elements can engage suitable mating detent elements of the absorber cover (2) and form detachable connections so that a reflector element (5), in case of damage, can be easily and quickly replaced.

The present invention relates to a secondary reflector for a Fresnel collector, comprising an absorber cover which is connected to at least one reflector element formed as a glass molding with a reflector side and a rear side with the interposition of an adhesive arranged on the rear side of the reflector element.

In a Fresnel solar field, incoming sunlight is bundled with the help of primary mirrors and directed onto an absorber tube, which runs elevated through the primary mirror field. In this case, the accuracy of the bundling is not arbitrarily high so that the placement of the focal line on the absorber tube works only imperfectly. Therefore, secondary reflectors are used, which increase the target aperture of the primary mirror field. Rays reflected from the primary mirror field that do not directly strike the absorber tube are reflected by the secondary reflector back to the rear side of the absorber tube and can thus be used. The task of the secondary reflector is not actually the concentration, but rather the redirection of radiation that reaches the entrance aperture of the absorber but misses the absorber tube, onto the absorber.

Due to high temperatures and UV radiation density, as well as the exposure of the absorber to external weathering, the reflectors are exposed to thermal and mechanical stresses, which both the materials and the suspension technology must withstand.

The secondary reflectors are glued directly into a supporting metal support structure. The secondary reflector has a parabolic U-shape. For this purpose, relatively high-strength adhesive bonds are used between the respective reflector element and the absorber cover, which both create a tolerance compensation between the materials used and compensate for the different thermal expansion of these two materials.

Since the adhesive connection is a permanent connection and accessibility is very limited, in the event of damage to the secondary reflector the entire absorber cover with its support assembly must be dismantled and taken to a workshop in order to install a new reflector element there.

Due to the difficult accessibility and height of the structure, this entails a high expenditure of time and money, as machines such as lifting platforms and cranes must be used to reach the absorber in the primary mirror field.

Against this background, the object of the present invention is that of creating a secondary reflector for a Fresnel collector, which reduces the effort of removal and installation and minimizes the downtime of the Fresnel collector in the event of damage.

This is achieved by a secondary reflector according to the features of independent claim 1. Further expedient embodiments can be found in the subsequent dependent claims.

According to the invention, a secondary reflector for a Fresnel collector is provided, comprising an absorber cover which is connected to at least one reflector element with a reflector side and a rear side with the interposition of an adhesive arranged on the rear side of the reflector element, the adhesive being arranged between at least two connecting elements and the rear side of the reflector element, and the connecting elements each having an adhesive surface for the planar connection to the reflector element, and a detent element for the releasable mechanical connection to mating detent elements of the absorber cover.

Although the adhesive still allows as close as possible a connection between the materials, according to the present invention the connection is no longer made directly between the absorber cover and the reflector element, but rather between the reflector element and a connecting element. Such a detachable connection in the form of a glued-on joining part, which can deform elastically during final assembly and then hook onto a mating detent means of the absorber cover, allows, in the event of damage to the reflector element, only this reflector element with its connecting elements to be unhooked from the absorber cover and replaced with a spare part that has already been kept ready in advance. The downtimes during which the primary mirror array has to be taken out of operation are thereby reduced to a minimum. The joining parts are applied to the reflector elements in an adhesion process. The adhesion process is therefore not tied to the location of the assembly process in the absorber assembly and can, for example, already take place at the manufacturer of the reflector elements. The transportability of the assembled reflector elements is not impaired, since the packaging volume is not significantly increased by the connecting elements applied on the rear side.

With regard to the material of the reflector elements, a variety of solutions are conceivable. Glass mirrors, especially thermally bent glass mirrors, are considered particularly advantageous, but these can also be made of aluminum, stainless steel or other carrier materials and the production can include other processes in addition to thermal bending.

Furthermore, the detent elements of the connecting elements can be designed with some advantage as T-shaped hooks, which engage in mating detent elements of the absorber cover in the form of T-shaped recesses, with an insertion slit and a slot extending transversely from this in the middle.

The T-shaped hook represents a particularly resilient form of a detent means, which can be hooked into an easily constructed mating detent means in the form of a T-shaped recess. In this case, the crossbar of the T-shaped hook is introduced into the insertion slit on the absorber cover and the vertical support bar of the T-shaped hook is then pushed along the slot to its end, or to another end position. In this case, such a connection is particularly flat and can be produced cost-effectively, as well as being easy to operate.

In a specific embodiment of this solution, the absorber cover can have fixed bearings and sliding bearings as mating detent elements for the detent elements of a reflector element, one or more fixed bearings being provided in one length position in the longitudinal direction and sliding bearings being formed at all other length positions.

The background to these considerations is the different linear expansions of the material of the absorber and the reflector element, which differ from one another. The reflector element is then held more or less immobile on the absorber cover at a fixed bearing, which can be located, for example, in the middle of the reflector element, while the connecting elements, which are spaced apart in the longitudinal direction of the absorber cover, are designed as sliding bearings, i.e. can compensate for linear expansion when locked in place.

Specifically, this can be solved structurally in that the plain bearings have a wider slot than the fixed bearings. If in this case the support beams of the T-shaped hooks always have the same width, namely such that they can slide in the slots of the fixed bearings, then this allows a longitudinal expansion when suspended, which can be compensated by a transverse displacement of the support beam in the slot. In this case, the crossbars of the T-shaped hooks and the corresponding insertion slits of the mating detent means should preferably be dimensioned in such a way that the crossbars still rest on both sides of the slot even at maximum deflection.

In order to lock the connecting elements in the insertion slits, it can be provided that the connecting elements have at least one locking spring which, in an end position of the reflector element with respect to the absorber cover, engages in the insertion slit of the absorber cover, which is arranged adjacent to a corresponding mating detent element. This can provide a locking mechanism that prevents the connecting means from accidentally slipping out of the mating detent means. Rather, in such a case, the locking spring must first be actuated, i.e. pushed out of the locking window or the insertion slit of the absorber cover, before the detent means and mating detent means can be moved again against the insertion direction and ultimately separated from each other.

In a specific embodiment, the locking spring can be bent out as a spring tab from an adhesive surface of a connecting element. It is helpful for this if the connecting elements are made of spring steel.

Preferably, for such a secondary reflector, in each case two or more reflector elements can be arranged parallel to one another in the absorber cover. For this purpose, the original single, U-shaped reflector element is divided into two half-shells, which improves accessibility as they can be placed around the absorber tube from both sides. The clearance required for removal is maintained by an intermediate gap between adjacent reflector elements.

The above-described invention is explained in more detail below with reference to an embodiment.

In the drawings:

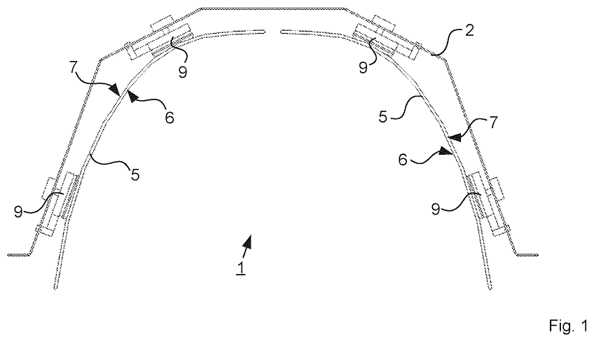

FIG. 1 is a cross-sectional view of a secondary reflector with an absorber housing and two reflector elements mounted therein,

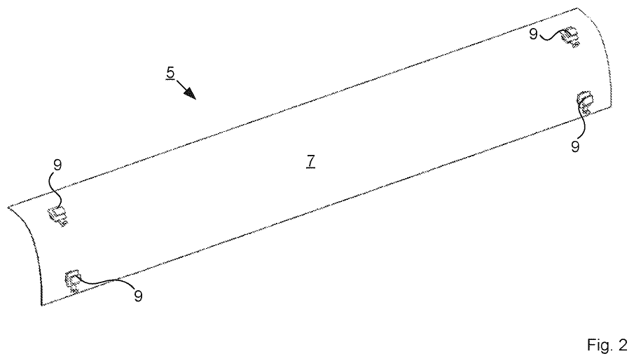

FIG. 2 is a perspective view of a single reflector element with connecting elements attached thereto,

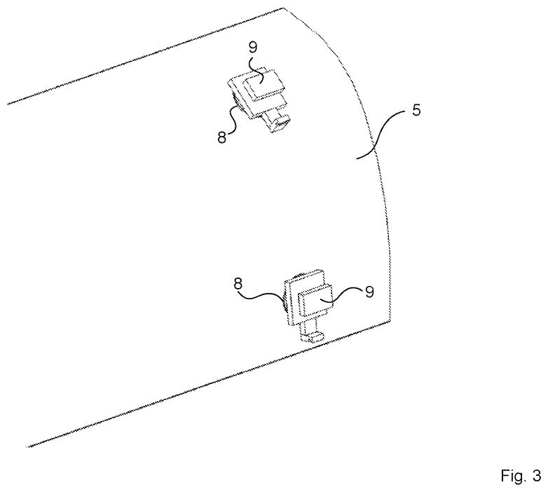

FIG. 3 is a detail of FIG. 2 with two connecting elements,

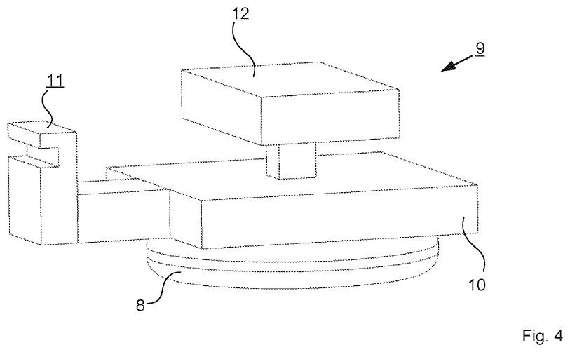

FIG. 4 is a detail of FIG. 3 with one connecting element, and

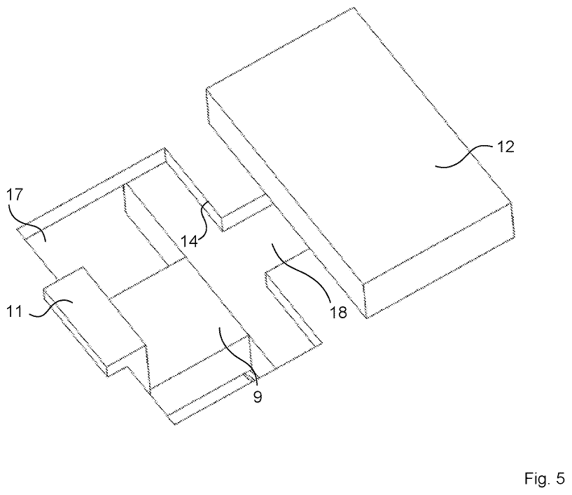

FIG. 5 is a perspective view of the connecting element according to FIG. 4 after it has been snapped into an insertion slit of an absorber cover.

FIG. 1 shows a secondary reflector 1, which is essentially composed of an absorber cover 2 and two reflector elements 5 arranged therein. The secondary reflector 1 serves, in a Fresnel solar field, to reflect sunlight guided past an absorber tube (not shown here) arranged below the secondary reflector 1 and to reflect it back onto the absorber tube from the rear side in order to use this radiation efficiently.

In this case, the reflector elements 5 are designed as thermally bent half-shells, which are highly reflective on their concave reflector side 6 and have a convex rear side 7, to which connecting elements 9 are glued, with the help of which the reflector elements 5 are mechanically connected to the absorber cover. Such a reflector element 5 is shown in FIG. 2. This has a total of four connecting elements 9, which are arranged in two rows one above the other and glued to the rear side 7 of the reflector element 5. As shown in FIG. 3, the connecting elements 9 contact the reflector element 5 with an adhesive 8 in between, which on the one hand establishes the connection between the connecting element 9 and the reflector element 5, but on the other hand fills the gap between the reflector element 5 and the absorber cover 2 later located above it.

FIG. 4 shows a connecting element 9 in a greater level of detail. The connecting element 9 has two surface elements, a lower one of which forms the adhesive surface 10. In this case, the holding element 12 is designed to be particularly stable, so that it is suitable for suspending the reflector element 5 on the absorber cover 2. On one side of the connecting element 9, a locking spring is machined out of the adhesive surface 10. Since the connecting element 9 is made of spring steel, the locking spring can be used to engage in a locking window of the absorber cover 2 and to provide a counter-hold there, so that an unintentional unhooking of the connecting means 9 from the insertion slit 17 is prevented.

FIG. 5 shows this situation. The holding element 12 of the connecting element 9 is guided through the insertion slit 17 through the absorber cover 2 and then inserted along a slot 18 which adjoins the middle of the insertion slit 17. The contour of the holding element 12 of the connecting element 9 is thereby mechanically connected to the material of the absorber cover 2, so that the attached reflector element 5 cannot fall down. In the inserted position, the connecting element 9 is then held in place by the locking spring engaging with its bent-out free end into the insertion slit 17, which thereby functions as a locking window. Simply by pressing the locking spring down under the edges of the insertion slit 17, the connection between the detent element 11 of the connecting element 9 and the insertion slit 17 of the absorber cover 2 is released again and the holding element 12 can then be moved again along the slot 18 in the direction of the insertion slit 17 and removed via this.

What is described above is thus a secondary reflector for a Fresnel collector, which reduces the effort required for removal and installation and minimizes the downtimes of the Fresnel collector in the event of damage.

### LIST OF REFERENCE SIGNS

1 secondary reflector
2 absorber cover
3 fixed bearing
4 sliding bearing
5 reflector element
6 reflector side
7 rear side
8 adhesive
9 connecting element
10 adhesive surface
11 detent element
12 holding element
17 insertion slit
18 slot

1: A secondary reflector for a Fresnel collector, comprising an absorber cover (2) which is connected to at least one reflector element (5) formed as a glass molding with a reflector side (6) and a rear side (7) with the interposition of an adhesive (8) arranged on the rear side (7) of the reflector element (5), wherein the adhesive (8) is arranged between at least two connecting elements (9) and the rear side (7) of the reflector element (5), the connecting elements (9) each having an adhesive surface (10) for the surface connection to the reflector element (5) and a detent element (11) for the releasable mechanical connection to mating detent elements of the absorber cover (2), the detent elements (11) of the connecting elements (9) being designed as T-shaped hooks which engage in mating detent elements of the absorber cover (2) in the form of T-shaped recesses, with an insertion slit (17) and a slot (18) extending centrally from the latter transversely thereto.

2: The secondary reflector according to claim 1, wherein the absorber cover (2) has fixed bearings (3) and sliding bearings as mating detent elements for the detent elements (11) of a reflector element (5), one or more fixed bearings (3) being provided in one length position in the longitudinal direction and sliding bearings (4) being formed at all other length positions.

3: The secondary reflector according to claim 2, wherein the sliding bearings (4) have a wider slot than the fixed bearings (3).

4: The secondary reflector according to claim 1, wherein the connecting elements (9) have at least one locking spring which, in an end position of the reflector element (5) with respect to the absorber cover (2), engages in the insertion slit (17) or a locking window of the absorber cover (2), which is arranged adjacent to a corresponding mating detent element.

5: The secondary reflector according to claim 4, wherein the locking spring is bent out as a spring tab from an adhesive surface (10) of a connecting element (9).

6: The secondary reflector according to one claim 4, wherein the connecting elements (9) are made of spring steel.

7: The secondary reflector according to claim 1, wherein in each case two reflector elements (5) are arranged in parallel with one another in the absorber cover (2).
